(19) United States
(12) Patent Application Publication
(10) Pub. No.: US 2020/0131744 A1
(43) Pub. Date: Apr. 30, 2020

(54) Well Water System and Tank Adaptor

(71) Applicants: Gregory Hunt, Rolling Prairie, IN (US); Chris Allan Hunt, Rolling Prairie, IN (US)

(72) Inventors: Gregory Hunt, Rolling Prairie, IN (US); Chris Allan Hunt, Rolling Prairie, IN (US)

(21) Appl. No.: 16/669,054

(22) Filed: Oct. 30, 2019

Related U.S. Application Data
(60) Provisional application No. 62/753,006, filed on Oct. 30, 2018.

(51) Int. Cl. E03B 7/07; E03B 3/08; E03B 5/04; E03B 11/08; F16K 17/02

(52) U.S. Cl. CPC E03B 7/071; E03B 3/08; F16K 17/02; E03B 11/08; E03B 5/045

(57) ABSTRACT

A well water system includes a pressure switch adapted to monitor air pressure within a pressure tank, rather than water pressure within plumbing. The pressure switch is connected directly to the pressure tank by a tank adaptor in fluid communication with the pressurized air inside the tank. With the tank adaptor directly connecting the pressure tank to the pressure switch, the pump is actuated based on air pressure changes within the tank rather than water pressure changes in the plumbing. The pressure switch is calibrated to activate the pump when the air pressure within the pressure tank drops below a predetermined pressure, which correlates to a certain water pressure within the system. When the air pressure within the pressure tank is restored to a predetermined maximum, the pressure switch deactivates the pump having filled the tank to the desired maximum water threshold.

This application claims the benefit of U.S. Provisional Application No. 62/753,006 filed Oct. 30, 2018, the disclosure of which is hereby incorporated by reference.

This invention relates to well water system, and in particular a system that actuates the well pump based on air pressure within the pressure tank.

### BACKGROUND AND SUMMARY OF THE INVENTION

Well water systems, generally, consist of a well itself, a pump, a pressure tank, a pressure switch for automatically activating the pump and the various connecting plumbing, valves, spigots and faucets. The pressure tank and pressure switch are used to maintain water pressure within the system's plumbing and provide immediate access to well water without operating the pump. The pump sends water from the well to the pressure tank for temporary storage. Pressure tanks use air pressure within the tank to pressurize the water feed back into the plumbing. Most pressure tanks use either internal bladders or diaphragms to separate the stored water from the air inside the tank. The pressure switch actuates the pump in response to a drop in water pressure below the minimum value to replenish the water in the tank and to build up the water pressure in the system to its maximum value. The pressure switch de-actuates the pump when the water pressure reaches the maximum value and the supply is restored.

In conventional practice, the pressure switch directly monitors water pressure in the system plumbing, generally in the water line from the pressure tank's outlet. Integrating the pressure switch into the plumbing requires additional joints, pipes and fittings. While common and generally acceptable in the art, adding more joints, pipes and fittings in the plumbing increases the potential for leaks and failures, as well as additional costs. Since the plumbing carries pressurized well water, any leaks or failures can cause significant damage.

The well water system of this invention differs from conventional well water systems, in that the pressure switch is adapted to monitor air pressure within the pressure tank, rather than water pressure within the plumbing. The pressure switch is connected directly to the pressure tank by a tank adaptor in fluid communication with the pressurized air inside the tank. With the tank adaptor directly connecting the pressure tank to the pressure switch, the pump is actuated based on air pressure changes within the tank rather than water pressure changes in the plumbing. The pressure switch is calibrated to activate the pump when the air pressure within the pressure tank drops below a predetermined pressure, which correlates to a certain water pressure within the system. When the air pressure within the pressure tank is restored to a predetermined maximum, the pressure switch deactivates the pump having filled the tank to the desired maximum water threshold. Placing the pressure switch in an air line, rather than a water line, eliminates potential water leaks and certain plumbing issues, that can lead to costly water damage to the system and surrounding structures. The use of a pressure switch in the air line, rather than the water line also does not significantly change the configuration or function of any system component, plumbing or wiring, keeping system installation, operation and maintenance familiar, while reducing installation cost and increasing reliability.

The above described features and advantages, as well as others, will become more readily apparent to those of ordinary skill in the art by reference to the following detailed description and accompanying drawings.

### BRIEF DESCRIPTION OF THE DRAWINGS

The present invention may take form in various system and method components and arrangement of system and method components. The drawings are only for purposes of illustrating exemplary embodiments and are not to be construed as limiting the invention. The drawings illustrate the present invention, in which:

FIG. 1 is a simplified side view of a conventional well water system illustrating an example of the prior art in the field;

FIG. 2 is a simplified side view of an exemplary well water system of this invention;

FIG. 3 is an exploded view of the pressure tank adaptor and pressure switch of this invention as shown in FIG. 2;

FIG. 4 is an exploded view of the pressure tank, tank adaptor and pressure switch of this invention as shown in FIG. 2;

FIG. 5 is a simplified side view of another exemplary well water system of this invention;

FIG. 6 is a perspective view of another exemplary tank adaptor of this invention; and

FIG. 7 is an exploded view of the tank adaptor of FIG. 6.

### DESCRIPTION OF THE PREFERRED EMBODIMENT

In the following detailed description of the preferred embodiments, reference is made to the accompanying drawings that form a part hereof, and in which is shown by way of illustration specific preferred embodiments in which the invention may be practiced. These embodiments are described in sufficient detail to enable those skilled in the art to practice the invention, and it is understood that other embodiments may be utilized and that logical, structural, mechanical, electrical, and chemical changes may be made without departing from the spirit or scope of the invention. To avoid detail not necessary to enable those skilled in the art to practice the invention, the description may omit certain information known to those skilled in the art. The following detailed description is, therefore, not to be taken in a limiting sense, and the scope of the present invention is defined only by the appended claims.

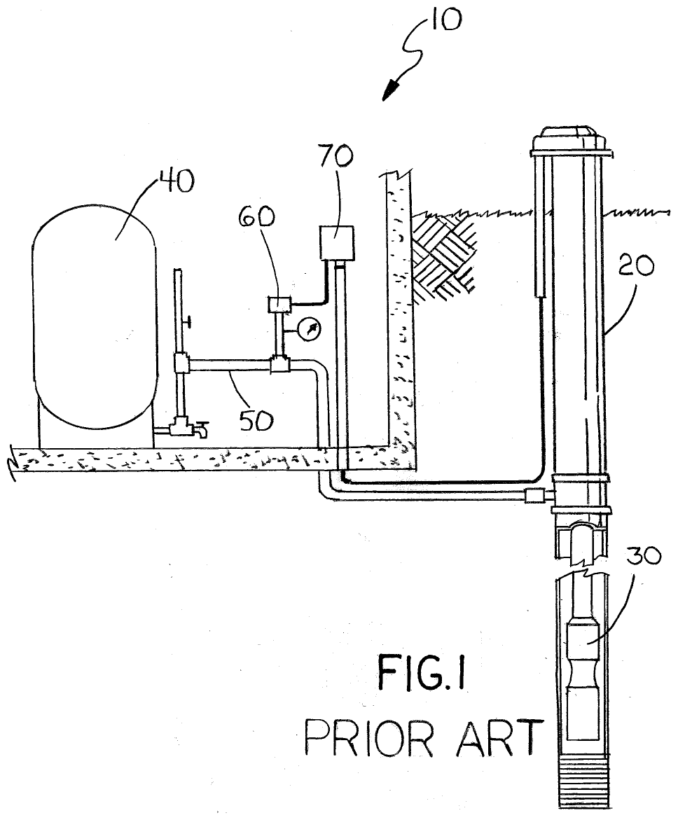

FIG. 1 illustrates a conventional well water system 10 that is presented to assist in the explanation of the prior art and conventional practices of basic well water systems, which may be contrasted to the present invention described further below. Well water systems 10 generally consist of a well casing 20, submersible pump 30, pressure tank 40, plumbing 50, pressure switch 60, and an electrical relay 70. Well casing 20 extends into the subterranean aquifer. Pump 30 is disposed within well casing 20 below the water line. Pressure tank 40 is remotely located and pump 30 feeds pressure tank 40 through plumbing 50. Plumbing 50 includes various pipes, joints, valves, spigots and faucets. Pressure switch 60 is operatively connected within plumbing 50 and detects the water pressure in the system. Electrical wires 72 connect pressure switch 60 to relay 70. Relay 70 electrically wires pump 30 to a power source (not shown) and actuates pump 30 in response to an electrical signal from pressure switch 60.

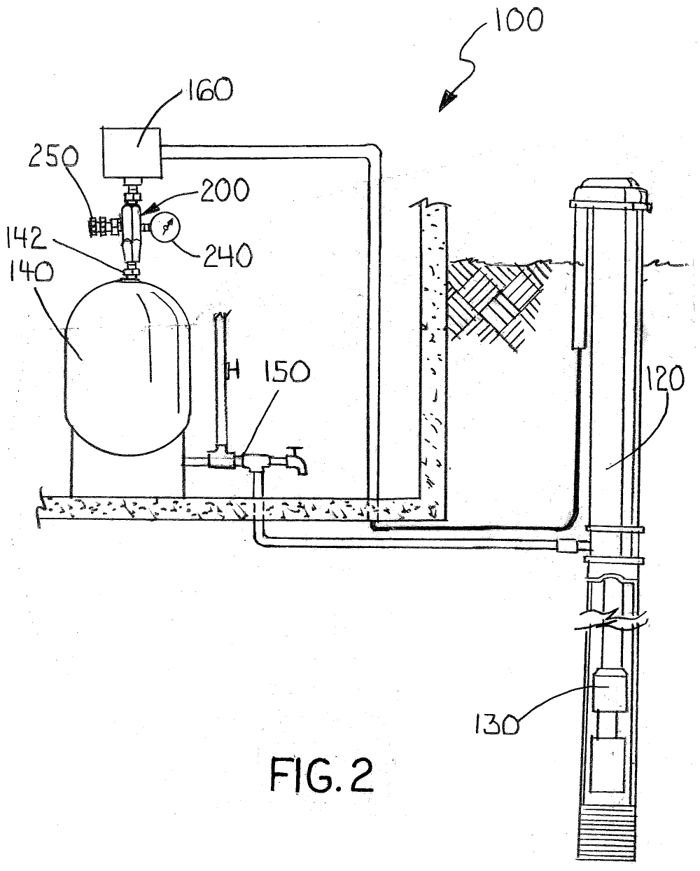

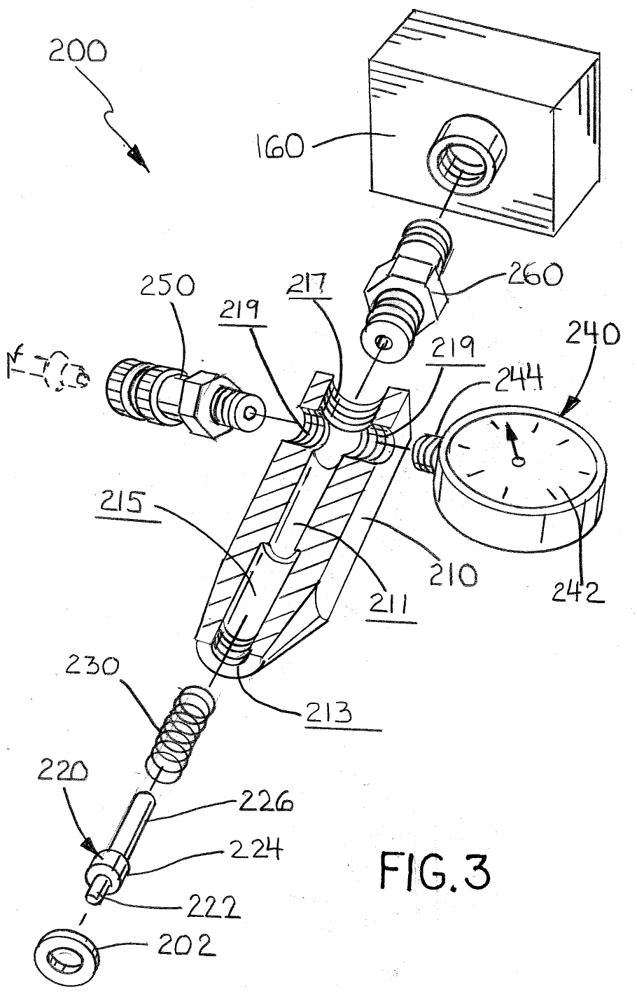

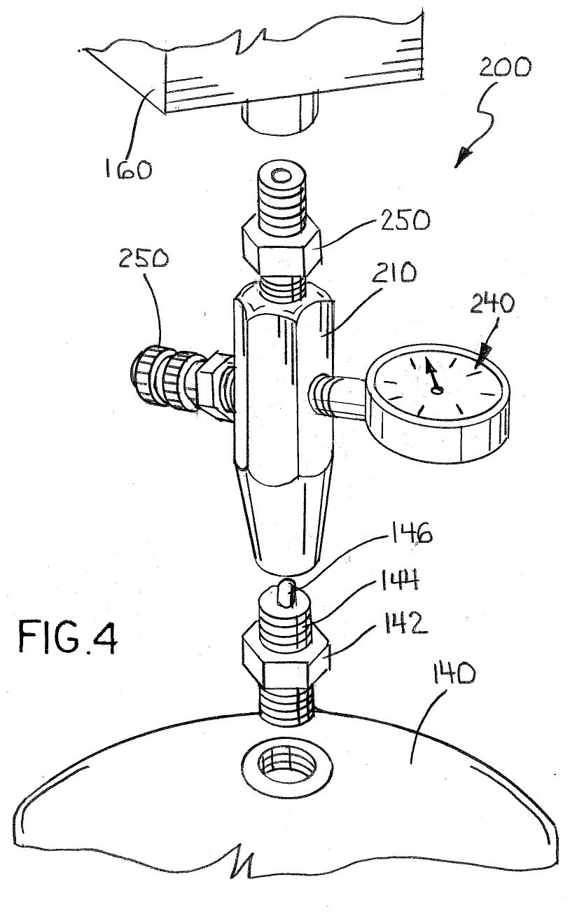

Referring now to the drawings, FIGS. 2-4 illustrate an exemplary embodiment of the well water system of this invention, which is designated generally as reference numeral 100. As with a conventional system, well water system 100 consists of a well casing 120, submersible pump 130, pressure tank 140, plumbing 150, pressure control 160, which may take the form of in certain applications and systems as conventional pressure transducers or pressure switchs, and an electrical relay 170. Again, well casing 120 extends into the subterranean aquifer. Pump 130 is disposed within well casing 120 and feeds pressure tank 140 through standard plumbing 150. As shown, pressure control 160, is a pressure switch electrically wired to pump 130 and an external power source (not shown), which actuates the pump in response to an electrical signal from pressure control 160.

The pumps, pressure tanks, relays and plumbing used in well water system 100 are all standard commercially available components for conventional design and function, well known in the art. In every case, well water system 100 of this invention differs from conventional well water systems, such as the one described above, in that the pressure control 160 is adapted to monitor air pressure within pressure tank 140, rather than water pressure within plumbing 150. Pressure control 160 is connected to pressure tank 140 by a tank adaptor 200 in fluid communication with the pressurized air inside the tank. In other exemplary embodiments, pressure control 160 may take the form of a combination of pressure sensor and transducer, which are also commonly used in well water systems; however, such sensor and transducer combinations still monitor and actuate pump 120 based on air pressure within pressure tank 120, and not the water within the plumbing.

Tank adaptor 200 includes a hollow body 210, a pressure gauge 240, a pneumatic coupler 250 adapted for connection to an external air source and a pneumatic connector 260 adapted for interface with pressure control 160. Adaptor body 210 is a long hollow member cast or machined from a suitable material, such as brass or aluminum. Adaptor body 210 has an open axial passage 211 that extends the length of the body. A valve pin 220 and helical spring 230 are disposed within a pin channel 215 of passage 211. Valve pin 220 is machined or cast to have a head 222, an annular collar 224 and shaft 226. Spring 230 is seated on pin shaft 226 and compressed between collar 224 and an internal shoulder 212 from between passage 211 and pin channel 215. Valve pin 220 is dimensioned to shiftably seat within pin channel 215 and passage 211, so as to provide open fluid communication through adaptor body 210. In addition, adaptor body 210 has a thread tank port 113 and a threaded switch port 117 at opposite ends of open passage 211. Adaptor body 210 also has two threaded side ports 219 that open into passage 211. Pressure gauge 240 is of conventional design and function and includes a gauge body 242 and threaded male connector 244 turned into one of the side ports 219. A pneumatic coupler 250 is a conventional quick connect pneumatic coupler, such as the MNPT M Style coupler manufactured by Milton Industries, Inc. of Chicago, Ill. Coupler 150 allows the quick attachment of air lines from a conventional air compressor to initially inflate and pressurize tank 140 as necessary. It should be noted that unless the coupler 150 is connected to a mating component of the air line, the couple is “closed” sealing its threaded side port 219. Pneumatic connector 260 is also of conventional design and interfaces adaptor body 210 in open fluid communication to pressure control 160. Typically, the body of pressure control 160 turns onto the threaded end of connector 260, which is turned into threaded port 217 of adaptor body 210.

As shown, tank adaptor 200 is configured to affix directly to air valve 142 of pressure tank 140. Generally, air valve 142 is a “Schrader” or “American” type or similar pneumatic valve used to connect the tank to an air source, such as the air line from an air compressor, for initially pressurizing the tank. Air valve 142 has a threaded head 144 and a valve core 146. Tank adaptor 200 is affixed to pressure tank 140 by turning threaded tank port 213 of adaptor body 219 onto the threaded head of tank valve 142 with a gasket 202. When affixed, valve pin 220 under the force of spring 230 depresses valve core 146 of tank 142 to provide open fluid communication from the tank through passage 211 to pressure switch 160. In other embodiments of this invention, the interface between the tank adaptor and air valve may vary depending on the type and configuration of the pressure tank.

With tank adaptor 200 connecting pressure tank 140 to pressure switch 160, pump 130 is actuated based on air pressure changes within the tank rather than water pressure changes in plumbing 150. Pressure switch 160 is calibrated to activate pump 130 when the air pressure within pressure tank 140 drops below a predetermined pressure, which correlates to a certain water pressure within plumbing 150. When the air pressure within pressure tank 140 is restored to a predetermined maximum, pressure switch 160 deactivates pump 130 having filled the tank to the desired maximum water threshold.

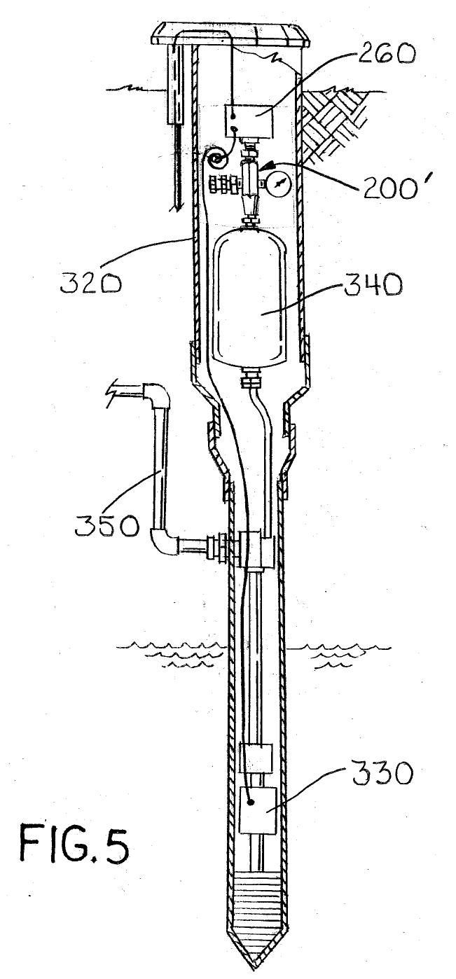

FIG. 5 illustrates a second exemplary embodiment of the well water system of this invention, which is designated generally as reference numeral 300. Well water system 300 is a typical “pitless” system and operates in the same manner as well water systems 10 and 100 above. In well water system 300, pressure tank 340 is disposed within the well casing 310. Again, pressure switch or pressure transducer 360 is connected directly to pressure tank 340 by a tank adaptor 200′ in fluid communication with the pressurized air inside the tank, and pump 330 is actuated based on air pressure changes within the tank rather than water pressure changes in the plumbing. Tank adaptor 200′ is mounted directly to the air valve (not shown) of pressure tank 340, which locates coupler 250′ where it is easily accessible from the well head. With easy access to coupler 250′, an air line can be readily connected to pressure tank 340 through adaptor 200′ to initially fill and periodically pressurize the tank as required.

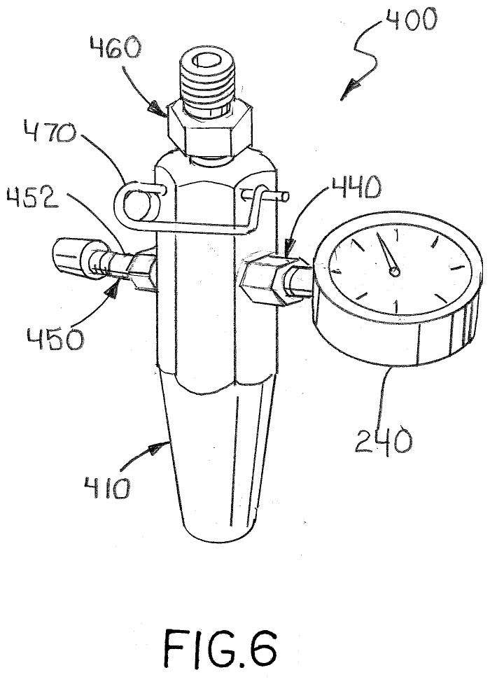

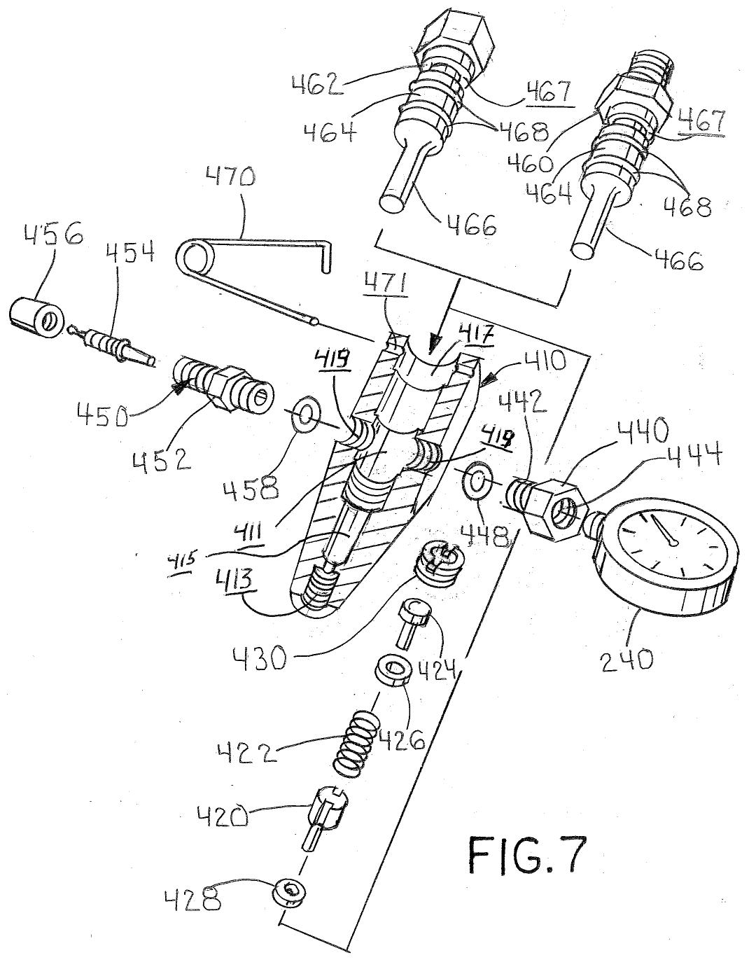

FIGS. 6 and 7 illustrate a second exemplary embodiment of the tank adaptor of this invention, which is designated generally as reference numeral 400. Tank adaptor 400 is similar to tank adaptor 200 in function and use within the well system, but provides increased leak preventions with the use of multiple O-rings. Tank adaptor body 400 also includes an integrated “Schrader valve” 450, an integrated gauge fitting 440, a pair of interchangeable switch/transducer heads 460 and 462. Switch/transducer heads 460 and 462 can be selectively fitted to adaptor body 410 for use with either a conventional pressure switch or a convention pressure transducer as pressure controls. Each of the Schrader valve stem 450, gauge port 440 and heads 460 and 462 have one or more 0-rings that hermetically seal their connections to adaptor body 410.

Adaptor body 410 is a long hollow member cast or machined from a suitable material, such as brass or aluminum. Adaptor body 410 has an open axial passage 411 that extends the length of the body with a threaded tank end 413 and an open switch/transducer end 417 at opposite ends of open passage. Adaptor body 410 also has two threaded side ports 419 that open into passage 411. As before, adaptor body 410 houses internal valve components that provided selective fluid communication through passage 411. The internal valve components including a valve pin 420, helical spring 422, valve head 424 and valve gasket 426 are disposed within a valve channel 415 of passage 411. Spring 422 is seated between valve pin 420 and valve head 424. The valve components are held within valve channel 415 by an externally threaded annular barrel 430 that turns into an internally threaded section of passage 411.

Gauge fitting 440 allows a conventional pressure gauge 240 to be directly affixed to adaptor body 410. Gauge fitting 440 has an externally threaded male end 442 and an internally threaded female end 444 that is adapted to received the male end of a conventional pressure gauge (not shown). The male end 442 is turned into one of the side ports 419 and is sealed by O-ring 448.

Air valve 450 includes a valve stem 452 that houses an internal valve component 454. Valve stem 452 has an externally threaded male end that turns into side port 419 and is sealed by O-ring 458. Air valve 450 functions as a conventional “Schrader” valve and allows air to be added to a connected pressure tank through adapter body 410, replacing pneumatic coupler 250 of the previous embodiment.

Switch/transducer heads 460 and 462 are identical in construction and function with head 460 having a threaded male end adapted to affix to a conventional pressure switch (not shown) and head 462 having a threaded female end adapted to be affixed to a conventional pressure transducer (not shown). Heads 460 and 462 have a hollow body 464 with a neck 466 configured to seat within end 417. Heads 460 and 462 each have a pair of O-rings 468 seated in annular grooves formed around body 464, which allow the heads to be press fitted into adaptor body 410. Switch/transducer heads 460 and 462 are secured to adaptor body 410 by a safety pin 470 that extends through a cross bore 471 in adaptor body 410 and rests across an annular groove 467 in the switch/transducer heads. The press fit connection and locking safety pin, allow switch/transducer heads 460 and 462 to be quickly interchanged without tools.

One skilled in the art will note that placing the pressure switch in an air line, rather than a water line, eliminates potential water leaks and certain plumbing issues, that can lead to costly water damage to the system and surrounding structures. Eliminating the pressure switch from the plumbing also reduces the installation costs of the system. Using the pressure switch to monitor air pressure in the pressure tank also conveniently locates the switch atop the pressure tank where it is easily accessible, which is particularly useful in pitless well water systems. The use of a pressure switch in the air line, rather than the water line also does not significantly change configuration or function of any system component, plumbing or wiring, keeping system installation, operation and maintenance familiar, while reducing cost and increasing reliability.

It should be apparent from the foregoing that an invention having significant advantages has been provided. While the invention is shown in only a few of its forms, it is not just limited but is susceptible to various changes and modifications without departing from the spirit thereof. The embodiment of the present invention herein described and illustrated is not intended to be exhaustive or to limit the invention to the precise form disclosed. It is presented to explain the invention so that others skilled in the art might utilize its teachings. The embodiment of the present invention may be modified within the scope of the following claims.

We claim:

1. A water pressure system comprising:
a pump for pumping water from a water bearing aquifer;
a pressure tank connected to the pump by a water conduit, the pressure tank including an inlet end, an outlet end, and an outer housing that is fillable with water from the submersible pump for storing a reserve of water;
a tank adaptor mounted to the pressure tank; and
a pressure control mounted to the tank adaptor in fluid communication with the air within the pressure tank for monitoring air pressure in the pressure tank and controlling operation of the pump,
the tank adaptor includes an adaptor body mountable to the pressure tank and the pressure switch in fluid communication with the air within the pressure tank, the adaptor body has an internal body passage therethrough between the pressure tank and the pressure switch, the tank adaptor includes an internal air valve disposed within the body passage and operatively associated with the pressure tank.

2. The tank adaptor of claim 1 wherein the adaptor body includes an external air valve connected to the adaptor body for connection to an air supply source.

3. The tank adaptor of claim 2 wherein the air valve is a Schrader type valve.

4. The tank adaptor of claim 2 wherein the air valve includes a pneumatic coupler.

5. The tank adaptor of claim 1 wherein the air valve includes a valve stem mounted to the adaptor body and sealed by an O-ring.

6. The tank adaptor of claim 1 wherein the adaptor body includes a pressure gauge and a fitting mounted to the adaptor body and sealed by an O-ring, the pressure gauge mounted to the fitting.

7. In a water supply system including a pump for pumping water from a water bearing aquifer, a pressure tank connected to the pump by a conduit, and a pressure switch for actuating the pump, a tank adaptor comprising:
an adaptor body mountable to the pressure tank and the pressure control for fluid communication with the air within the pressure tank, the adaptor body has an internal body passage therethrough in open fluid communication between the pressure tank and the pressure switch, the adaptor body having an internal air valve disposed within the body passage and adapted for operative association with the pressure tank.

8. The tank adaptor of claim 7 wherein the adaptor body includes an external air valve connected to the adaptor body for connection to an air supply source.

9. The tank adaptor of claim 8 wherein the air valve is a Schrader type valve.

10. The tank adaptor of claim 8 wherein the air valve includes a pneumatic coupler.

11. The tank adaptor of claim 8 wherein the external air valve includes a valve stem mounted to the adaptor body and sealed by an O-ring.

12. The tank adaptor of claim 7 wherein the adaptor body includes a pressure gauge and a fitting mounted to the adaptor body and sealed by an O-ring, the pressure gauge mounted to the fitting.
